(19) United States
(12) Patent Application Publication
(10) Pub. No.: US 2026/0204683 A1
(43) Pub. Date: Jul. 16, 2026

(54) ELECTRIC BATTERY INCORPORATING A DEVICE FOR THERMAL MANAGEMENT OF AN ELEMENT OF A POWERTRAIN

(71) Applicant: RENAULT S.A.S., Boulogne Billancourt (FR)

(72) Inventors: Philippe DUMAND, Les Ulis (FR); Sebastien HUBERT, Courtaboeuf (FR); Charles JOVIC, Les Ulis (FR)

(73) Assignee: RENAULT S.A.S., Boulogne Billancourt (FR)

(21) Appl. No.: 19/135,689

(22) PCT Filed: Dec. 7, 2023
(86) PCT No.: PCT/EP2023/084813

§ 371 Date: Jun. 4, 2025

(30) Foreign Application Priority Data
Dec. 14, 2022 (FR) FR2213361

(51) Int. Cl. H01M 10/6568; B60K 1/04; B60L 50/60; B60L 58/26; H01M 10/625; H01M 50/249

(52) U.S. Cl. CPC H01M 10/6568; B60K 1/04; B60L 50/66; B60L 58/26; H01M 10/625; H01M 50/249; B60K 2001/0438; H01M 2220/20

(57) ABSTRACT

An arrangement of an electric vehicle, which has a thermal management device, includes at least one heat exchanger and at least one element to be thermally regulated belonging to an electric drivetrain, such a powertrain. The vehicle also includes a battery positioned under the vehicle, such as under the passenger compartment floor. The thermal management device is arranged inside the battery.

The invention relates to an arrangement for an electric vehicle having a thermal treatment device, which comprises at least one heat exchanger and at least one element to be thermally regulated of an electric drive chain. The invention relates to a vehicle having such an arrangement and to a method for producing such an arrangement.

Electric motor vehicles traditionally comprise a chassis underneath which, in particular in the central portion, below the passenger compartment, is disposed a modular electrical energy storage assembly which includes electric battery cells. The powertrain, comprising in particular the electric motor, can be placed at the front of the chassis for a front wheel drive vehicle, at the rear of the chassis for a rear wheel drive vehicle, or partly at the front and partly at the rear of the chassis for a four wheel drive vehicle.

The problems with vehicles that have a rear powertrain are related in part to the thermal management of its components, in particular when the thermal management involves a heat transfer fluid flowing in a circuit between at least one element that is to be thermally managed and is situated at the rear of the vehicle and at least one heat exchanger situated at the front of the vehicle.

It is known practice to produce a circuit for the flow of a heat transfer fluid by means of pipes made of plastic, such as EPDM®, or steel, such as aluminum, such pipes being then fitted underneath the vehicle body.

It has been found that this known solution is difficult to apply to electric vehicles given that the underbody environment is greatly limited by the presence of said electrical energy storage assembly.

The invention seeks to provide a solution to the aforementioned problem.

The invention falls within this context and seeks to provide an arrangement for an electric vehicle and also a method for producing such an arrangement that overcome the above disadvantages.

In particular, the invention targets an arrangement for an electric vehicle having a thermal treatment device, which comprises at least one heat exchanger, and at least one element to be thermally regulated of an electric drive chain, in particular a powertrain, the vehicle having a battery positioned in particular underneath the vehicle, in particular underneath the floor of the passenger compartment.

The arrangement to which the invention relates is characterized in that the thermal treatment device is disposed inside the battery.

According to other particular features, the arrangement may comprise the following features, taken separately or in combination with one another:
the battery comprises at least one interfacing element connecting the battery to the vehicle chassis, in particular underneath the passenger compartment of the vehicle,
the thermal treatment device comprises at least one pipe, in particular made up of a rigid tube for the circulation of a heat transfer fluid, in particular a glycol water-based fluid, making it possible to thermally treat at least one element of the electric drive chain, in particular a powertrain,
the rigid tube is disposed inside the interfacing element,
the rigid tube is disposed inside the interfacing element such that at least one end of the rigid tube projects out of the interfacing element,
the pipe comprises at least one flexible tube connected to the rigid tube by a female connector,
the female connector is assembled at one of the ends of the interfacing element, in particular by screwing,
the rigid tube comprises at least one fixing tab, in particular welded to an external portion of the rigid tube,
the battery interfacing element comprises at least one bracket for the fixing of the thermal treatment device, in particular for the fixing of the rigid tube via the female connector or the fixing tab,
the rigid tube comprises at least one insulating insert, fixed in particular by adhesive bonding, such that the insert breaks the thermal bridge between the rigid tube and the interfacing element.

The invention also relates to an electric vehicle comprising an arrangement having any one of the aforementioned features.

The invention also relates to a method for producing the arrangement, which comprises the following steps:
producing the rigid tube and the interfacing element,
positioning the rigid tube inside the interfacing element, in particular inside a channel passing longitudinally through the interfacing element, by sliding it in from one end of the interfacing element,
fixing the rigid tube by one of its ends, in particular by screwing or riveting,
assembling the rigid tube and a female connector,
fixing the female connector to the interfacing element, in particular by screwing or riveting.

Further details, features and advantages will become more clearly apparent from reading the detailed description given below by way of non-limiting indication, in relation to the various embodiment examples illustrated in the following figures:

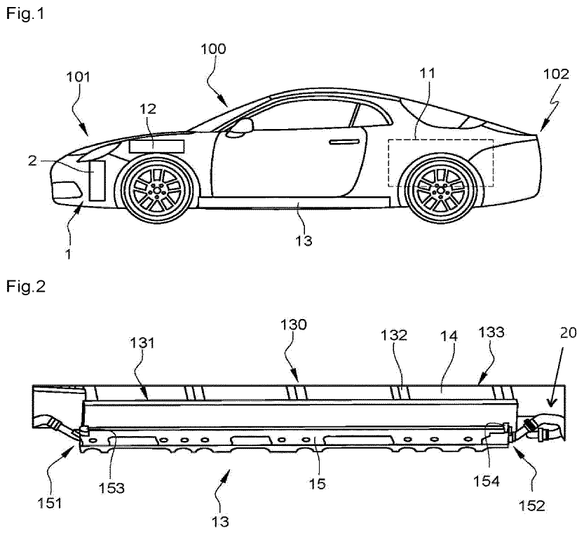

FIG. 1 is a schematic depiction of a vehicle according to the arrangement of the invention,

FIG. 2 is a partial depiction, in perspective, of a battery and a thermal treatment device, according to the invention,

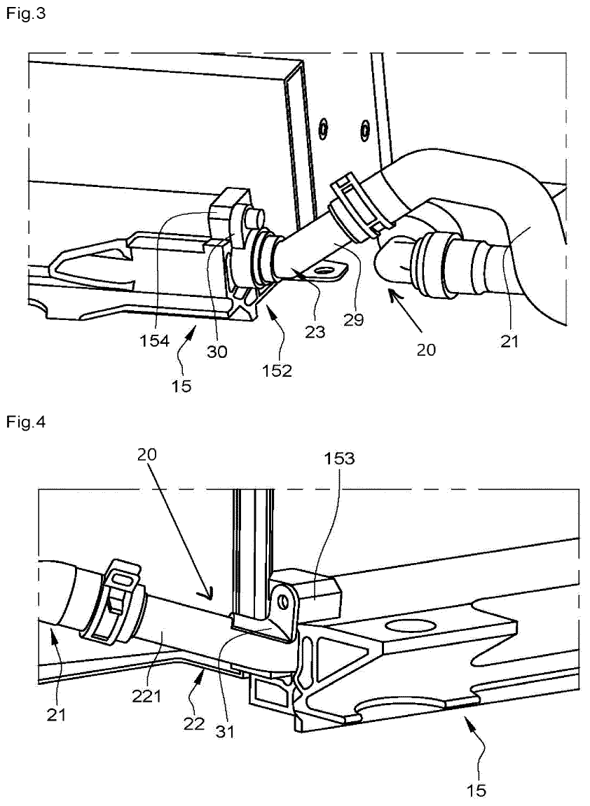

FIG. 3 is an enlarged view of the rear portion of the battery in FIG. 2,

FIG. 4 is an enlarged view of the front portion of the battery in FIG. 2,

FIG. 5 is a view, in longitudinal section, of the arrangement in FIG. 3,

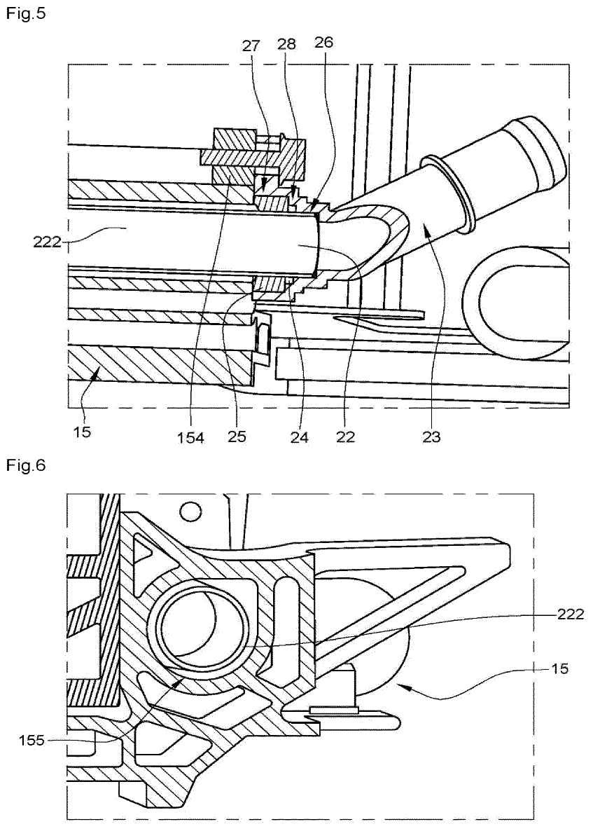

FIG. 6 is a view, through the cross section VI-VI, of the arrangement in FIG. 4.

FIG. 1 schematically illustrates a motor vehicle 100 equipped with a thermal treatment device 1. The vehicle 100 may be of any type, i.e. it may be a private vehicle, a utility vehicle, a truck or a bus. The vehicle 100 may also be an autonomous or non-autonomous vehicle. In this case, FIG. 1 shows a sports car which has the particular design feature of the powertrain being located at the rear, and this powertrain needs to be cooled by exchanges of heat performed near the front of the vehicle, close to air inlet openings.

In particular, the vehicle 100 has an electric power unit. In this sense, it comprises an electric drive chain which includes an electric powertrain 11 of the vehicle 100, at least one power electronics element 12 and an electric drive battery 13, also likely to be referred to more generally hereinafter as “battery”, “battery module” or “pack battery”, for storing electrical energy and supplying this electrical energy to at least one component of the drive chain.

The vehicle 100 also comprises a thermal treatment device 1 in which a heat transfer fluid can circulate in order to flow through the electric powertrain 11, at least one power electronics element 12 and/or the electric battery 13, so that these components can be heated or cooled depending on their individual requirements.

The vehicle 100 comprises a front compartment 101 containing a heat exchanger 2 of the heat transfer fluid/air type. The heat exchanger 2 may be of the front-end radiator type through which ambient air flows in order to cool the heat transfer fluid. The front compartment 101 may also comprise at least one power electronics element 12. The vehicle 100 comprises a rear compartment 102 containing the electric powertrain 11. The battery 13 is disposed underneath the floor of the passenger compartment of the vehicle, between the front compartment 101 and rear compartment 102.

Because the electric powertrain 11 is located at the rear of the vehicle, and the heat exchanger 2 is located at the front of the vehicle, the battery 13 is used to circulate the heat transfer fluid. To this end, the battery 13 comprises a frame 130 which is shown in FIG. 2. The frame 130 may be approximately parallelepipedal, at the very least having mutually parallel lateral edges. The frame 130 comprises longitudinal beams 131, in particular on the right and left sides, that delimit the lateral edges of the battery 13. The frame 130 comprises mutually parallel transverse beams 132 connecting the longitudinal beams 131 to one another in order to form compartments 133 each containing a module 14 of electric battery cells. In FIG. 2, the transverse beams 132, together with the longitudinal beams 131, define four longitudinally adjacent compartments 133. The transverse beams 132 are preferably substantially perpendicular to the longitudinal beams 131.

The longitudinal beams 131 and transverse beams 132 can be obtained by extrusion of an alloy, in particular an aluminum alloy. They may have a hollow cross section with stiffening walls that connect the interior walls of the beam to one another.

In order to connect the battery 13 to the vehicle body, from the bottom side, the battery 13 comprises interfacing elements 15 secured to the longitudinal beams 131, preferably by welding. Each interfacing element 15 is in the form of a one-piece part which extends over virtually the entire length of a longitudinal beam 131. The interfacing element 15 can also be referred to as a battery bottom runner hereinafter.

The battery bottom runner 15 has opposite ends 151, 152 on which brackets 153, 154 for fixing constituent elements of the thermal treatment device 1 are positioned, as shown in detail in FIGS. 3 to 5.

The thermal treatment device 1 comprises at least one pipe 20 which is fluidically connected to the heat exchanger 2 and to the electric powertrain 11. The pipe 20 is made up of at least one rigid tube 22. It may comprise at least one flexible tube 21 that can be connected to the rigid tube 22 or to an element of the electric drive chain.

FIG. 3 and FIG. 5 show the assembly of the thermal treatment device 1 on the battery bottom runner 15. At one of the ends 152 of the battery bottom runner 15, the flexible tube 21 is connected to the rigid tube 22 via a female connector 23.

The rigid tube 22 projects out of the rear end 152 of the bottom runner 15. The female connector 23 comprises a receiving chamber 26 which receives the free end of the rigid tube 22, as shown in FIG. 5.

The receiving chamber 26 comprises a first sealing zone 27, forming a portion of the internal wall of the female connector 23, in which there is a ring 25. The receiving chamber 26 may comprise a second sealing zone 28 which continues the first and contains an O ring 24. The second sealing zone 28 forms another portion of the internal wall of the female connector 23.

The ring 25 is substantially of conical profile and made of steel, in particular copper, aluminum, or of plastic.

The insertion of the rigid tube 22 into the interior causes the ring 25 to be pressed against the internal wall of the first sealing zone 27, thereby placing the O ring 24 under load against the shoulder of the internal wall of the second sealing zone 28.

The receiving chamber 26 for the rigid tube comprises an annular wall which continues the second sealing zone 28 and against which the free end of the rigid tube 22 bears, give or take assembly tolerances.

The internal walls of the receiving chamber 26 for the rigid tube 22, of the first and second sealing zones 27, 28 accommodating the sealing ring 25 and the O ring 24, respectively, each have a substantially cylindrical cross section and are mutually coaxial, in particular about an axis normal to the rigid tube 22.

The female connector 23 comprises a tubing 29 which can be inclined, in particular upwardly inclined as shown in FIG. 5, with respect to the axis of revolution of the zones 27, 28 and of the chamber 26, thereby enabling the flexible tube 21 then fitted on the tubing to be placed as close as possible to the battery 13. The free end of the tubing 29 may comprise an inverted chamfer forming a first means for retaining the flexible tube 21 on the female connector 23. The tubing 29 may comprise an axial stop formed by a flange situated at a predetermined distance from the free end of the connector 23. The aim of such a stop is to limit the length to which the flexible tube 21 is fitted on the female connector 23. The tubing 29 may moreover comprise retaining ridges which are disposed on the exterior face of the tubing 29, in particular between the stop and the free end, such that a means for retaining the flexible tube 21 on the female connector 23 is formed. To improve the fluidic connection between the flexible tube 21 and the female connector 23, a clamping collar can be used to subject the flexible tube 21 to radial load against the tubing 29, as FIG. 3 shows.

In order to ensure the female connector 23 is fixed to the bottom runner 15, the female connector 23 comprises a radial protrusion forming a fixing tab 30 which projects from the first sealing zone 27 delimiting an end face of the female connector 23 and is intended to bear against the rear bracket 154 of the bottom runner 15. The fixing tab has an opening through which a clamping screw can extend, the clamping screw having a threaded shank which engages with a tapped hole formed through the rear bracket 154 of the bottom runner 15.

The female connector 23 is fitted and screwed to the bottom runner 15 via the fixing tab 30.

FIG. 4 shows the other end of the rigid tube 22 which extends out of the front end 153 of the bottom runner 15. The projecting end of the rigid tube 22 may be inclined with respect to a rectilinear portion of the rigid tube 22, the other end of which is intended to be received inside the bottom runner 15 and the female connector 23. This makes it possible to reduce the bulk of the thermal treatment device 1 underneath the vehicle body.

Because the rigid tube 22 has a greater dimension than the length of the bottom runner 15, a portion of the rigid tube 22 is disposed outside the bottom runner, in this case projecting forwards. This projecting portion may be referred to as an external portion 221 of the rigid tube 22 compared to the rectilinear portion of the rigid tube 22, which is disposed inside the bottom runner and can thus be referred to as an internal portion 222 of the tube. The external portion 221 of the tube 22 may be inclined with respect to an internal portion 222 of the rigid 22 tube 22.

The external portion 221 comprises a radially extending fixing tab 31. In the same way as the connection of the female connector 23 described above, this external portion 221 of the rigid tube 22 is fixed by screwing to the bracket 153 disposed at the front end of the bottom runner 15. The front bracket 153 comprises, in the same way as the rear bracket 154, a tapped hole for the screwing of the rigid tube 22.

In one embodiment variant, the rigid tube could be fixed by riveting.

Another flexible tube 21 may be assembled on the front external portion 221 of the rigid tube 22, this front external portion having a substantially identical design to that of the female connector 23 described above. In this sense, the free end of the external portion 221 may comprise an inverted chamfer forming a first means for retaining the flexible tube 21 on the rigid tube 22. The external portion 221 may comprise an axial stop formed by a flange situated at a predetermined distance from the free end of the rigid tube 22. The aim of such a stop is to limit the length to which the flexible tube 21 is fitted on the rigid tube 22. The external portion 221 may moreover comprise retaining ridges which are disposed on the exterior face of the rigid tube 22, in particular between the stop and the free end, such that a means for retaining the flexible tube 21 on the rigid tube 22 is formed. To improve the fluidic connection between the flexible tube 21 and the rigid tube 22, a clamping collar can be used to subject the flexible tube 21 to radial load against the rigid tube 22, thereby improving the fixing.

The bottom runner 15 is produced by extrusion, in particular made of an alloy, such as an aluminum alloy for example. The front bracket 153 and rear bracket 154 of the bottom runner 15 can be fixed to the front and rear ends, respectively, of the bottom runner 15 by braze-welding.

FIG. 6 shows a cross section of the bottom runner 15, revealing a channel 155 extending longitudinally along the bottom runner. The rectilinear portion of the rigid tube 22 extends inside the channel at a spacing from the latter such that an air circulation space is created around the periphery of the rigid tube 22.

It is important to break the thermal bridge that might exist between the bottom runner 15 and the thermal treatment device 1 by means of a gap allowing air to flow naturally between the rigid tube 22 and the bottom runner 15.

In order to maintain the peripheral gap between the rigid tube 22 and the channel of the bottom runner 15, and thus avoid any vibratory effects on the rigid tube likely to generate noise, at least one insulating insert is fitted on the rigid tube 22. The insulating insert may be fixed in particular by adhesive bonding. The insulating insert may be made of plastic, in particular deformable plastic. However, in order to allow the rigid tube 22 to slide through one of the ends, in particular the front end 151 of the bottom runner 15, the material used to manufacture the insulating insert has a reduced coefficient of friction. The material used to manufacture the insulating insert may for example be polyamide or polypropylene.

In order to minimize the transfer of heat between the rigid tube 22 and the bottom runner 15, besides the insert which breaks the thermal bridge, the channel 155 leads through at least one vent, preferably several vents distributed uniformly along the bottom runner 15. The use of several air vents makes it possible to create a turbulent flow around the rigid tube 22 while the vehicle is moving, and this promotes the exchange of heat between the heat transfer fluid circulating in the rigid tube and the ambient air. The assembly consisting of the bottom runner 15 and the rigid tube 22 acts as an additional heat exchanger to that of the radiator 2. Air can thus flow through the channel 155 such that the effect of a transfer of heat from the internal portion 222 of the rigid tube 22 to the bottom runner 15 is virtually zero, or even absent.

The method for mounting the thermal treatment system 1 on the battery 13 will now be described.

It comprises the following steps:
producing the rigid tube 22 and the bottom runner 15,
positioning the rigid tube 22 inside the bottom runner 15, in particular inside the channel 155 passing longitudinally through the bottom runner 15, by sliding it in from one end, in particular a front end 151, of the bottom runner such that the fixing tab of the external portion 222 of the rigid tube 22 bears against the front fixing bracket 153,
fixing the external portion 222 to the bottom runner, in particular by screwing or riveting,
placing the sealing ring 25 onto the opposite end, in particular the rear end, of the rigid tube 22,
assembling the rigid tube 22 and the female connector 23,
fixing the female connector 23 to the bottom runner, in particular by screwing or riveting.

The method for mounting the thermal treatment device 1 on the battery 13 may also comprise the following steps:
producing the rigid tube 22, comprising a step of bending one of the ends in order to create an external portion 221 which is inclined with respect to the internal portion 222 of the rigid tube which is rectilinear;
producing the rigid tube 22, comprising a step of welding a fixing tab 31 intended to fix the tube to a dedicated bracket of the bottom runner, in particular a front bracket 153;
prior to the step of assembling the rigid tube 22 and the female connector 23, disposing the O ring 24 inside the second sealing zone 26 of the female connector 23;
fitting the flexible tube 21 onto the female connector 23, in particular onto the tubing 29, such that the flexible tube 21 bears against the axial stop;
fitting the flexible tube 21 onto the rigid tube 22, in particular onto the external portion 22, such that the flexible tube 21 bears against the axial stop;
retaining the flexible tube 21 on the female connector 23 and/or the rigid tube 22 by means of a clamping collar.

By proceeding as per the method mentioned above, an assembly of the thermal treatment device 1 with the battery 13 which is compact, can be implemented quickly, and does not run the risk of leaking is produced.

The compactness is afforded by one portion of the thermal treatment device 1 being positioned in the very interior of the battery 13, in particular via its bottom runner 15.

The present invention is not, however, limited to the means and configurations described and illustrated here and it also applies to any equivalent means or configuration and to any technically feasible combination of such means insofar as they perform, in fine, the functionalities described and illustrated.

1-12. (canceled)

13. An arrangement for an electric vehicle, comprising:
a thermal treatment device including at least one heat exchanger;
at least one element to be thermally regulated of an electric drive chain; and
a battery positioned underneath the vehicle,
wherein the thermal treatment device is disposed inside the battery.

14. The arrangement as claimed in claim 13, wherein the at least one element to be thermally regulated of an electric drive chain is a powertrain of the vehicle.

15. The arrangement as claimed in claim 13, wherein the battery is positioned underneath a floor of a passenger compartment of the vehicle.

16. The arrangement as claimed in claim 13, wherein the battery comprises at least one interfacing element connecting the battery to a chassis of the vehicle.

17. The arrangement as claimed in claim 16, wherein the thermal treatment device comprises at least one pipe made up of a rigid tube for circulation of a heat transfer fluid to thermally treat the at least one element of the electric drive chain.

18. The arrangement as claimed in claim 17, wherein the heat transfer fluid is a glycol water-based fluid.

19. The arrangement as claimed in claim 17, wherein the rigid tube is disposed inside the interfacing element.

20. The arrangement as claimed in claim 17, wherein the rigid tube is disposed inside the interfacing element such that at least one end of the rigid tube projects out of the interfacing element.

21. The arrangement as claimed in claim 17, wherein the pipe comprises at least one flexible tube connected to the rigid tube by a female connector.

22. The arrangement as claimed in claim 21, wherein the female connector is assembled at one end of the interfacing element.

23. The arrangement as claimed in claim 17, wherein the rigid tube comprises at least one fixing tab.

24. The arrangement as claimed in claim 23, wherein the at least one fixing tab is welded to an external portion of the rigid tube.

25. The arrangement as claimed in claim 21, wherein the rigid tube comprises at least one fixing tab and the battery interfacing element comprises at least one bracket to fix the rigid tube via the female connector or the fixing tab.

26. The arrangement as claimed in claim 17, wherein the rigid tube comprises at least one insulating insert such that the insert breaks a thermal bridge between the rigid tube and the interfacing element.

27. The electric vehicle, comprising the arrangement as claimed in claim 13.

28. A method for producing the arrangement as claimed in claim 17, comprising:
producing the rigid tube and the interfacing element;
positioning the rigid tube inside the interfacing element by sliding the rigid tube in from one end of the interfacing element;
fixing the rigid tube by one of its ends;
assembling the rigid tube and a female connector; and
fixing the female connector to the interfacing element.

29. The method as claimed in claim 28, wherein the rigid tube is positioned inside a channel passing longitudinally through the interfacing element.

30. The method as claimed in claim 28, wherein the rigid tube is fixed by screwing or riveting one of its ends.

31. The method as claimed in claim 28, wherein the female connector is fixed to the interfacing element by screwing or riveting.
